(19) United States
(12) Patent Application Publication
(10) Pub. No.: US 2009/0219454 A1
(43) Pub. Date: Sep. 3, 2009

(54) VIDEO OUTPUT APPARATUS AND VIDEO OUTPUT METHOD

(75) Inventors: Noriyasu Horigome, Ome-shi (JP); Hidekazu Masukawa, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/271,614

(22) Filed: Nov. 14, 2008

(30) Foreign Application Priority Data
Feb. 29, 2008 (JP) 2008-050570

(51) Int. Cl. H04N 9/31; H04N 5/50

(52) U.S. Cl. 348/744; 348/569; 348/E09.025; 348/E05.097

(57) ABSTRACT

According to one embodiment, a video output apparatus includes a processing module which executes a process for giving a predetermined display effect to an input video signal, a projecting module which generates an optical image based on the processed video signal so as to project the optical image onto a screen via a projection lens and display a video, and an output module which outputs the processed video signal to an outside.

### CROSS-REFERENCE TO RELATED APPLICATIONS

This application is based upon and claims the benefit of priority from Japanese Patent Application No. 2008-050570, filed Feb. 29, 2008, the entire contents of which are incorporated herein by reference.

### BACKGROUND

1. Field

One embodiment of the invention relates to a video output apparatus and a video output method which are used suitably in a projection type display apparatus such as a color projector.

2. Description of the Related Art

As is well known, since the above projection type display apparatuses frequently installed in places which house a lot of people, the display apparatuses are operated by PCs (personal computers) which are connected to the display apparatuses via LAN (local area networks) in control rooms prepared in places separately from the installation places.

In this case, operators of the PCs cannot operate the projection type display apparatuses while viewing images projected onto screens. For this reason, in the control rooms, the operators input video signals, which are input into the projection type display apparatuses, into monitors, and operate the projection type display apparatuses while viewing the images on the screens.

On the other hand, in recent projection type display apparatuses, images corresponding to input video signals are not directly projected onto screens for display. These projection type display apparatus have a function for giving various processes to input video signals so as to give various display effects to images to be projected onto the screens.

For this reason, at the present, such projection type display apparatuses are desirably operated so as to execute a process for giving the video display effects to video signals without actually viewing images projected onto the screens, namely, in any places. Further, the projection type display apparatuses desirably improve efficient use of video signals to which desirable display effects are given.

Jpn. Pat. Appln. KOKAT Publication No. 2005-266816 discloses a constitution of a projector which controls a memory function or a color converting function in a display apparatus in cooperation with an image signal from the information processing apparatus based on a control signal from an information processing apparatus so as to cutout-display a specific area of an image and display still images such as slide show with beautiful image quality according to image contents.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view illustrating an appearance of a color projector according to one example of the present invention;

FIG. 2 is a block constitutional diagram illustrating an outline of a signal processing system of the color projector according to the example;

FIG. 3 is a diagram illustrating one example of the color projector according to the example; and

FIG. 4 is a block constitutional diagram illustrating an outline of the video signal processing system in a television broadcasting reception apparatus according to another example of the present invention.

### DETAILED DESCRIPTION

Various embodiments according to the invention will be described hereinafter with reference to the accompanying drawings. In general, according to one embodiment of the invention, a video output apparatus includes a processing module which executes a process for giving a predetermined display effect to an input video signal, a projecting module which generates an optical image based on the processed video signal so as to project the optical image onto a screen via a projection lens and display a video, and an output module which outputs the processed video signal to an outside.

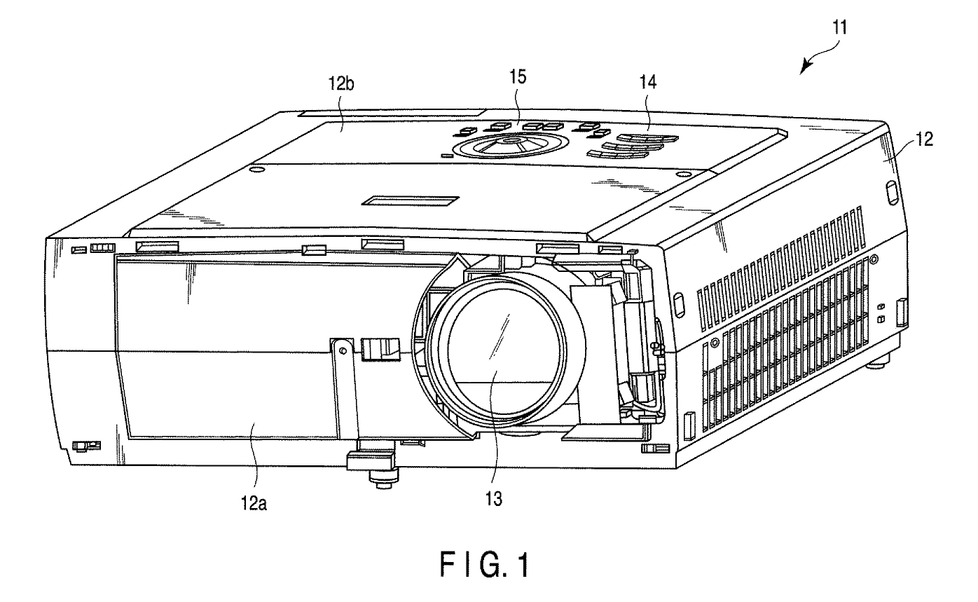

FIG. 1 illustrates an appearance of a color projector 11 described in this example. That is to say, the color projector 11 has a stationary cabinet 12 which becomes a projector main body and is formed into an approximately thin box shape.

A projection lens 13 is arranged on one end of a front panel 12a of the cabinet 12. The projection lens 13 is for enlarging and projecting so as to display imaged information onto a screen, described later, which becomes a video projection surface provided on the front surface of the cabinet 12.

A display module 14 and an operating module 15 are arranged on an upper panel 12b of the cabinet 12. The display module 14 displays a current state of the color projector 11, or a menu for setting various modes of the color projector 11.

The operating module 15 has a power supply key, and various keys which control various operating states or a halt state of the color projector 11, or sets various modes of the color projector 11. These keys are provided so as to be exposed from the upper panel 12b so as to be operated by a user.

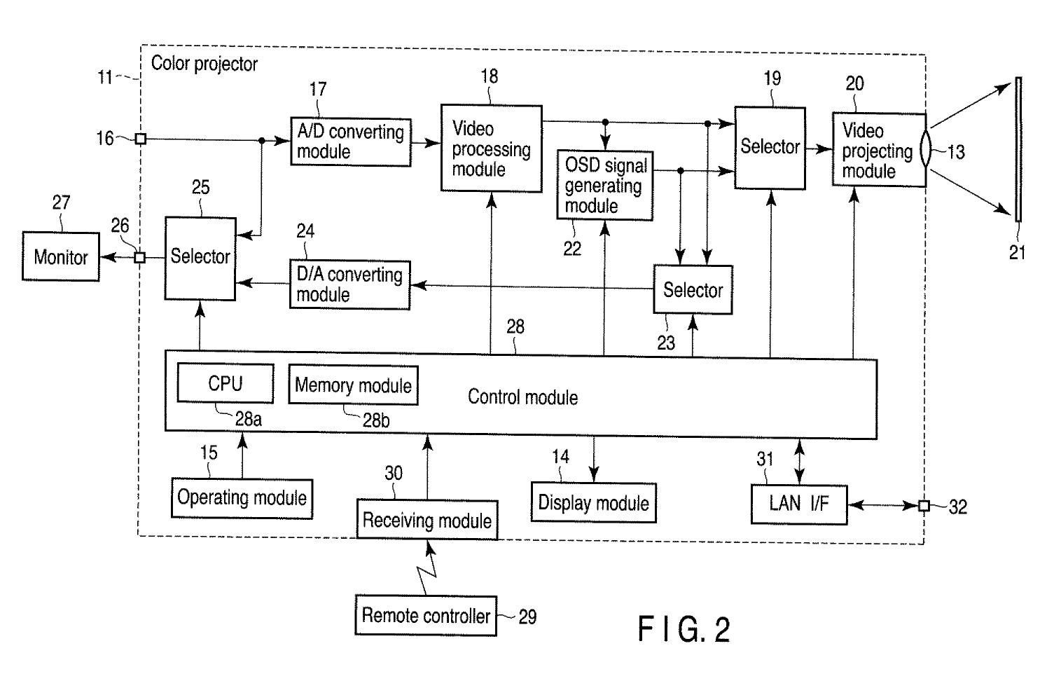

FIG. 2 schematically illustrates a signal processing system of the color projector 11. That is to say, a video signal supplied from an input terminal 16 is digitalized by an A/D (analog/digital) converting module 17, and is supplied to a video processing module 18 so as to be subject to processes for giving various display effects and a predetermined signal process necessary for projection.

Examples of the processes given to a video signal in the video processing module 18 are a muting process for stopping video output, a resizing process for converting a video size, a freezing process for making a video still, a PinP (picture in picture) process for displaying a sub-screen video on a predetermined position of a main screen video, and a multi-screen display process for dividing one screen into a plurality of areas so as to display videos on the respective areas.

When a selector 19 selects a video signal output from the video processing module 18, the video signal is supplied to a video projecting module 20 so as to be converted into an optical image, and is enlarged to be projected onto a screen 21 via the projection lens 13. The image to which a desired display effect is given is displayed on the screen 21.

A video signal output from the video processing module 18 is supplied to an OSD (on screen display) signal generating module 22. The OSD signal generating module 22 generates an OSD signal which shows an operating state of the color projector 11 and a menu screen or the like for selectively setting the various modes and the various processes. The OSD signal generating module 22 superimposes the OSD signal on the video signal output from the video processing module 18.

When the selector 19 selects the video signal on which the OSD signal is superimposed by the OSD signal generating module 22, the video signal is supplied to the video projecting module 20 so as to be converted into an optical image. Thereafter, the optical image is enlarged to be projected onto the screen 21 via the projection lens 13. As a result, the user views the OSD signal displayed on the screen 21 so as to be capable of recognizing the operating state of the color projector 11 or selectively setting the various modes and the various processes on the menu screen.

A selector 23 selectively supplies the video signal output from the video processing module 18 and the video signal on which the OSD signal is superimposed by the OSD signal generating module 22 to the D/A (digital/analog) converting module 24 so as to convert them into analog signals. The analog signals are supplied to one input terminal of a selector 25.

The video signal supplied to the input terminal 16 is supplied directly to the other input terminal of the selector 25. The selector 25 selectively leads the video signal output from the D/A converting module 24 and the video signal supplied to the input terminal 16 to an output terminal 26. The video signal output from the output terminal 26 is supplied to an external monitor 27 so as to be displayed as a video.

For this reason, when the selector 25 selects the video signal supplied to the input terminal 16, the original video signal input into the color projector 11 can be displayed as a video by the monitor 27 regardless of the video displayed on the screen 21, namely, the selecting state of the selector 19.

The selector 23 selects the video signal output from the video processing module 18, and the selector 25 selects the video signal output from the D/A converting module 24. As a result, the video signal subject to the process for obtaining a desired display effect by the video processing module 18 can be displayed as a video by the monitor 27 regardless of the selecting state of the selector 19.

The selector 23 selects the video signal output from the OSD signal generating module 22, and the selector 25 selects the video signal output from the D/A converting module 24. As a result, the video signal on which the OSD signal is superimposed by the OSD signal generating module 22 can be displayed as a video by the monitor 27 regardless of the selecting state of the selector 19.

The video display operation of the color projector 11 is controlled by a control module 28 in an integrated manner. The control module 28 contains a CPU (central processing unit) 28a, for example, and controls the respective modules based on operating information acquired from the operating module 15 or operating information transmitted from a remote controller 29 and received by a receiving module 30 so that their operating contents are reflected.

In this case, the control module 28 uses a memory module 28b. The memory module 28b mainly has a ROM (read only memory) and a RAM (random access memory) and a nonvolatile memory. The ROM stores a control program executed by the CPU 28a therein. The RAM provides an operation area to the CPU 28a. The nonvolatile memory stores various setting information and control information therein.

The control module 28 controls the display module 14 so as to display a current state of the color projector 11 or display a menu for setting the color projector 11 into various modes.

The control module 28 is connected to a control terminal (for example, PC), not shown, via LAN, namely a LAN I/F (interface) 31 and an input/output terminal 32. The control module 28 controls the respective modules based on operating information given from the control terminal so that their operation contents are reflected.

According to the example, the video signal output from the video processing module 18 or the signal obtained by superimposing the OSD signal on the video signal, namely, the video signal which was subject to a predetermined process for video display on the screen 21 can be output so as to be displayed as a video on the external monitor 27.

That is to say, the displayed video on the monitor 27 is viewed so that the video actually projected onto the screen 21 can be checked. For this reason, when the color projector 11 is operated through the control terminal, the operator of the control terminal can execute the process for giving the video display effect to a video signal without viewing the displayed video on the screen 21, namely, in any place.

When the selection of signals by the selectors 19, 23 and 25 is controlled, the video displayed on the screen 21 and the video displayed on the monitor 27 can be freely switched. For this reason, a practical effect is produced at the time of actual operation.

A video based on the video signal output from the video processing module 18 is displayed on the screen 21, and a video based on the video signal on which the OSD signal is superimposed is displayed on the monitor 27. When the OSD signal displayed on the monitor 27 is viewed, the operating state of the color projector 11 can be recognized, or the various modes or the various processes can be selectively set on the menu screen without being noticed by a person who views the displayed video on the screen 21.

The video obtained by the original video signal supplied to the input terminal 16 and the video which is obtained by giving the display effect to the video signal in the video processing module 18 can be viewed selectively on the monitor 27, or simultaneously on two-screen display. For this reason, user's operability can be made to be convenient.

Further, a plurality of monitors 27 is connected to the output terminal 26, so that the video signal which was subject to the processes in the video processing module 18 can be displayed as videos simultaneously on the plurality of monitors 27. That is to say, the display effects given to the video signal in one color projector 11 can be concurrently reflected on the plurality of monitors 27, and the video signal after the processes can be effectively used.

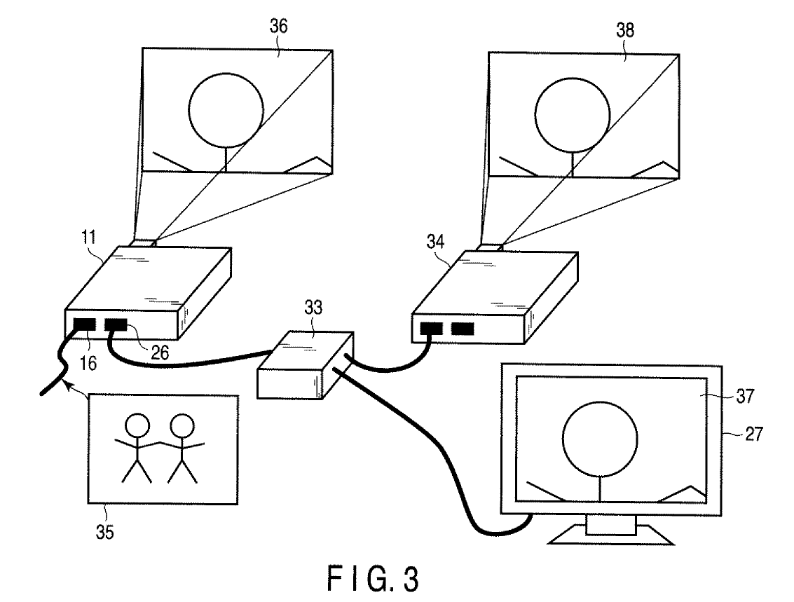

As shown in FIG. 3, the video signal output from the output terminal 26 of the color projector 11 can be supplied to the monitor 27 and another color projector 34 via a distributor 33.

In such a manner, when the video signal corresponding to a video 35 is supplied to the input terminal 16 of the color projector 11 and the video signal is subject to a process for enlarged display shown as a video 36 in the color projector 11, the processed video signal can be displayed like a video 37 on the monitor 27. Further, the video signal can be projected to be displayed like a video 38 in another color projector 34. That is to say, the display effects which are given to the video signal in the one color projector 11 can be concurrently reflected on the plurality of color projectors 34, and the processed video signal can be effectively used.

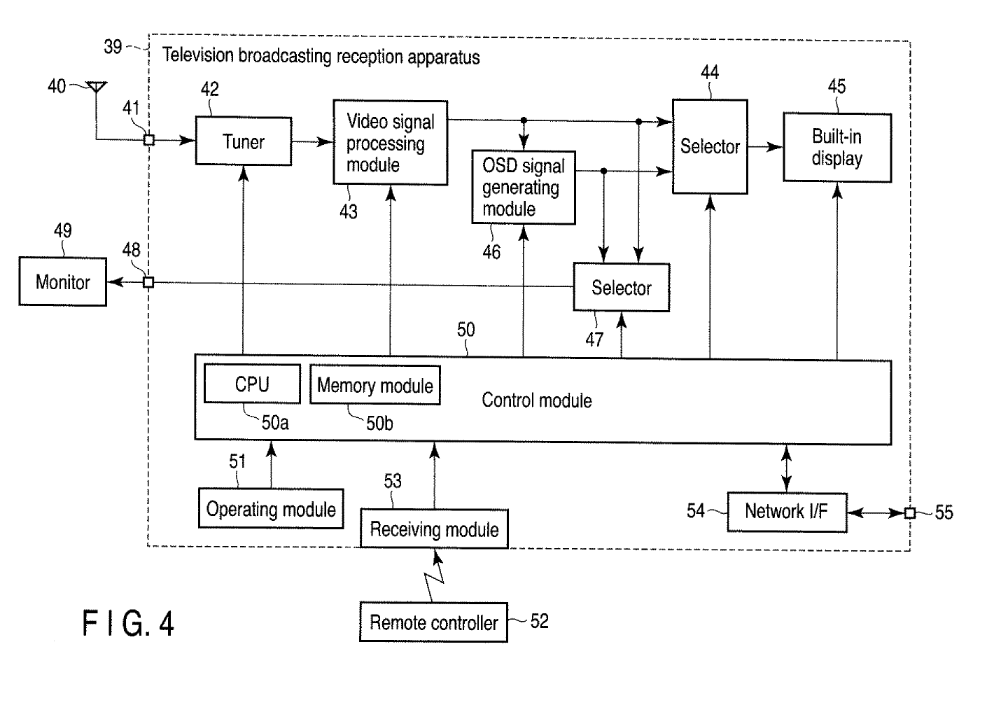

FIG. 4 illustrates another example of the present invention, and schematically illustrates the video signal processing system of a television broadcasting reception apparatus 39. That is to say, a television broadcasting signal received by an antenna 40 is supplied to a tuner 42 via an input terminal 41, so that a broadcasting signal at a desired channel is selected.

The broadcasting signal selected by the tuner 42 is supplied to a video signal processing module 43, and is subject to a demodulating process or a decoding process, if necessary, so as to be restored to an original video signal. Thereafter, the video signal is subject to processes for giving various display effects and a predetermined signal process necessary at the time of video display on a built-in display, described later.

Examples of the processes given to a video signal in the video signal processing module 43 are a muting process, resizing process, a freezing process, a PinP process, and a multi-screen display process. The muting process is for stopping video output. The resizing process is for converting a video size. The freezing process is for making a video still. The PinP process is for displaying a sub-screen video on a predetermined position in a main screen video. The multi-screen display process is for dividing one screen into a plurality of areas and displaying a video on the respective areas.

When the video signal output from the video signal processing module 43 is selected by a selector 44, it is supplied to the built-in display 45 so that a video is displayed. The video to which a desired display effect is given is displayed.

The video signal output from the video signal processing module 43 is supplied to an OSD signal generating module 46. The OSD signal generating module 46 generates an OSD signal showing an operating state of the television broadcasting reception apparatus 39 and a menu screen or the like for selectively setting the various modes and the various processes. The OSD signal is superimposed on the video signal output from the video signal processing module 43.

When the selector 44 selects the video signal on which the OSD signal is superimposed by the OSD signal generating module 46, the video signal is supplied to the built-in display 45 so that a video is displayed. As a result, the user views the OSD signal displayed on the built-in display 45, so as to be capable of recognizing the operating state of the television broadcasting reception apparatus 39 and selectively setting the various modes and the various processes on the menu screen.

A selector 47 selectively leads the video signal output from the video signal processing module 43 and the video signal on which the OSD signal is superimposed by the OSD signal generating module 46. The video signal output from the output terminal 48 is supplied to an external monitor 49 so that a video is displayed.

For this reason, when the selector 47 selects the video signal output from the video signal processing module 43, the video signal to which the process for obtaining a desired display effect is given by the video signal processing module 43 can be displayed as a video on a monitor 49 regardless of the selecting state of the selector 44.

When the selector 47 selects the video signal output from the OSD signal generating module 46, the video signal on which the OSD signal is superimposed by the OSD signal generating module 46 can be displayed as a video on the monitor 49 regardless of the selecting state of the selector 44.

The receiving operation of the television broadcasting reception apparatus 39 is controlled by the control module 50 in an integrated manner. The control module 50 contains a CPU 50a, for example, and controls the respective modules based on operating information acquired from an operating module 51 or operating information transmitted from a remote controller 52 and received by a receiving module 53 so that their operating contents are reflected.

In this case, the control module 50 utilizes a memory module 50b. The memory module 50b mainly has a ROM, a RAM and a nonvolatile memory. The ROM stores a control program executed by the CPU 50a therein. The RAM provides an operation area to the CPU 50a. The nonvolatile memory stores various setting information and control information therein.

The control module 50 is connected to an external network via a network I/F 54 and an input/output terminal 55. The control module 50 performs data communication with a control terminal and a server connected to the network, so as to input operating information and acquire necessary information.

According to the example shown in FIG. 4, the selection of signals by the selectors 44 and 47 is controlled, so that a video displayed on the built-in display 45 and a video displayed on the monitor 49 can be freely switched. For this reason, user's operability can be made to be convenient.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video output apparatus comprising:
an input module configured to input a video signal therein;
a processing module configured to execute a process for giving a predetermined display effect to the video signal input into the input module;
a projecting module configured to generate an optical image based on the video signal processed by the processing module and project the optical image onto a screen via a projection lens so as to display a video; and
an output module configured to output the video signal processed by the processing module to an outside.

2. A video output apparatus of claim 1, further comprising a selecting module configured to selectively supply the video signal processed by the processing module and the video signal input to the input module to the output module so as to output them to the outside.

3. A video output apparatus of claim 1, further comprising:
a superimposing module configured to superimpose an OSD signal on the video signal processed by the processing module;
a first selecting module configured to selectively supply the video signal on which the OSD signal is superimposed by the superimposing module and the video signal processed by the processing module to the projecting module so as to display a video on the screen; and
a second selecting module configured to selectively supply the video signal on which the OSD signal is superimposed by the superimposing module and the video signal processed by the processing module to the output module so as to output them to the outside.

4. A video output apparatus of claim 1, further comprising:
a superimposing module configured to superimpose an OSD signal on the video signal processed by the processing module;
a first selecting module configured to selectively supply the video signal on which the OSD signal is superimposed by the superimposing module and the video signal processed by the processing module to the projecting module so as to display a video on the screen; and
a second selecting module configured to selectively supply the video signal on which the OSD signal is superimposed by the superimposing module, the video signal processed by the processing module and the video signal input into the input module to the output module so as to output them to the outside.

5. A video output apparatus comprising:
a receiving module configured to receive a broadcasting signal;
a processing module configured to restore a video signal from the broadcasting signal received by the receiving module so as to execute a process for giving a predetermined display effect;
a built-in display configured to display a video based on the video signal processed by the processing module; and
an output module configured to output the video signal processed by the processing module to an outside.

6. A video output apparatus of claim 5, further comprising:
a superimposing module configured to superimpose an OSD signal on the video signal processed by the processing module;
a first selecting module configured to selectively supply the video signal on which the OSD signal is superimposed by the superimposing module and the video signal processed by the processing module to the built-in display so as to display a video on the display; and
a second selecting module configured to selectively supply the video signal on which the OSD signal is superimposed by the superimposing module and the video signal processed by the processing module to the output module so as to output them to the outside.

7. A video output method comprising:
inputting a video signal;
executing a process for giving a predetermined display effect to the input video signal;
generating an optical image based on the processed video signal so as to project the optical image onto a screen via a projection lens and display a video; and
outputting the processed video signal to an outside.

8. A video output method of claim 7, further comprising selectively outputting the processed video signal and the input video signal to the outside.

9. A video output method of claim 7, further comprising:
superimposing an OSD signal on the processed video signal;
selectively displaying the video signal on which the OSD signal is superimposed and the processed video signal as a video on the screen; and
selectively outputting the video signal on which the OSD signal is superimposed and the processed video signal to the outside.

10. A video output method of claim 7, further comprising:
superimposing an OSD signal on the processed video signal;
selectively displaying the video signal on which the OSD signal is superimposed and the processed video signal as a video on the screen; and
selectively outputting the video signal on which the OSD signal is superimposed, the processed video signal and the input video signal to the outside.
